(19) United States
(12) Patent Application Publication
(10) Pub. No.: US 2021/0304043 A1
(43) Pub. Date: Sep. 30, 2021

(54) EVALUATING A RECOMMENDER SYSTEM FOR DATA PROCESSING

(71) Applicant: INTERNATIONAL BUSINESS MACHINES CORPORATION, Armonk, NY (US)

(72) Inventors: Sujoy Kumar Roy Chowdhury, Kolkata (IN); Ria Chakraborty, Kolkata (IN); Kartikeya Vats, Dehradun (IN); Tanveer Akhter Khan, Indore (IN); Khyati Baradia, Bangalore (IN); Yogesh Narasimha, Bangalore (IN)

(21) Appl. No.: 16/830,926

(22) Filed: Mar. 26, 2020

(51) Int. Cl. G06N 7/00; G06Q 30/06; G06N 20/20; G06F 7/58

(52) U.S. Cl. CPC G06N 7/005; G06F 7/582; G06N 20/20; G06Q 30/0631

(57) ABSTRACT

An approach is provided for evaluating a recommender system. A user's purchase date of an item and attributes of the item are extracted from a test set. Drop probabilities are assigned to the attributes. Using bootstrapping with aggregation, queries for the user and the item are generated by omitting one or more attributes from each of the queries according to the drop probabilities. Data that became available to the recommender system after the purchase date is identified. Without using the identified data and using data that became available to the recommender system before the purchase date, ranked item recommendation sets for the queries are generated. Similarity at rank K (SIM@K) values for the recommendation sets are calculated. Average SIM@K values are calculated over multiple users specified in the test set. Based on the average SIM@K values, the performance of the recommender system is evaluated.

### BACKGROUND

The present invention relates to data processing management, and more particularly to evaluating recommender systems.

Recommender systems have become ubiquitous for the success of any customer-oriented solution. A recommender system acts as a filtering tool to help users process a significant number of options in a personalized manner. Because recommender systems have been driven by several kinds of needs, recommender systems have a great amount of variety and versatility. Recommender systems are classified as proactive or reactive. A proactive recommender system aims to recommend even when users do not actively seek a recommendation. A reactive recommender system aims to find and recommend the best possible set of items when users explicitly seek a recommendation. A user specifies feature(s) to personalize the search results and the reactive recommender system subsequently recommends items that possess the specified feature(s). Almost every recommender system is a result of several sub-processes and algorithms forming a pipeline and working in harmony. Each of these sub-processes and algorithms are dependent on several parameters.

### SUMMARY

In one embodiment, the present invention provides a method of evaluating a recommender system. The method includes extracting, by one or more processors, a date of a purchase of an item by a user and attributes of the item. The attributes and the date are extracted from a test set of data which is included in an initial data set specifying interactions between users and items. The method further includes assigning, by the one or more processors, drop probabilities to the attributes of the item based on measures of importance of the respective attributes in a decision by the user to purchase the item. The method further includes using bootstrapping with aggregation, generating, by the one or more processors, n queries for the user and the item by omitting one or more attributes from each of the queries according to the assigned drop probabilities. The method further includes identifying, by the one or more processors, data that became available to the recommender system after the date of the purchase of the item. The identified data is included in the initial data set and specifies interactions between one or more users and one or more items. The method further includes without using the identified data and using data that became available to the recommender system before the date of the purchase of the item, generating, by the one or more processors, n recommendation sets for the n queries, respectively. Each recommendation set has ranked items recommended for purchase by the user. The method further includes calculating, by the one or more processors, similarity at rank K (SIM@K) values for respective recommendation sets. A SIM@K value calculated for a given recommendation set indicates a similarity of a given ranked item in the given recommendation set to the item purchased by the user. The method further includes repeating, by the one or more processors and for one or more other users and one or more other users whose interactions are specified in the test set of data, the extracting the date and the attributes, the assigning the drop probabilities, the generating the n queries, the identifying the data that became available to the recommender system after the date of the purchase of the item, the generating the n recommendation sets for the n queries, and the calculating the SIM@K values. The method further includes calculating, by the one or more processors, average SIM@K values over multiple users specified in the test set of data. The method further includes based on the average SIM@K values, evaluating, by the one or more processors, a performance of the recommender system.

In other embodiments, the present invention provides a computer program product and a computer system whose associated methods are analogous to the method whose summary is presented above.

### BRIEF DESCRIPTION OF THE DRAWINGS

FIG. 1 is a block diagram of a system for evaluating a recommender system, in accordance with embodiments of the present invention.

FIG. 2 is a flowchart of a process of evaluating a recommender system, where the process is implemented in the system of FIG. 1, in accordance with embodiments of the present invention.

FIG. 3 is an example of a table of user-item pairs in used in the process of FIG. 2, in accordance with embodiments of the present invention.

FIG. 4 is an example of a table of bootstrapped queries used in the process of FIG. 2, in accordance with embodiments of the present invention.

FIG. 5 is an example of a table of products indicating a product for which a similarity measure is calculated in the process of FIG. 2, in accordance with embodiments of the present invention.

FIG. 6 is a block diagram of a computer included in the system of FIG. 1 and that implements the process of FIG. 2, in accordance with embodiments of the present invention.

### DETAILED DESCRIPTION

### Overview

Evaluating a recommender system requires two main components: an evaluation framework and a metric. Currently available implementations of evaluation frameworks either (i) rely on existing search terms to proceed with the evaluation or (ii) indicate recommender system performance in other terms, which lack a smooth translation in terms of business. When a recommender system is part of a green field implementation (e.g., a personalized search engine is to be implemented for the first time or a brick and mortar store wants to go online and have a recommender driven contextual search system to be built), unavailability of search terms becomes a bottleneck for translating the performance of the recommender system in a “could-have-been” scenario. The existing frameworks and methodologies for recommender evaluation are insufficient in that their generation of indicative performance numbers or indication of performance in other terms is not business intuitive and do not translate well in terms of a newly-built system. Many currently available evaluation methods use metrics such as Mean Average Precision at K (MAP@K), Mean Reciprocal Rank at K (MRR@K), or Normalized Discounted Cumulative Gain at K (NDCG@K), which fail to reflect the true performance of a recommender system, especially for the retail domain. The currently available metrics do not address peculiarities of the retail domain such as (1) products that are essentially the same being available under different Stock Keeping Unit (SKU) numbers (e.g., a product under one SKU is repackaged or rebranded for a particular promotion and is assigned a new SKU) and (2) different SKUs with essentially the same attributes differing only in size or volume of a product (e.g., a brand of shampoo which is packaged in different sizes, where each size is associated with a different SKU). By not addressing the aforementioned peculiarities, the current evaluation methods simply assess performance based on a SKU number match, which results in penalizing the recommender system too much.

Further, the several algorithms comprising a recommender system attempt to optimize and solve different respective subproblems. For example, using Matrix Factorization methods with implicit data is common when rating information is sparse or noisy. It is difficult to compare the effect of tweaking parameters related to the different algorithms in a single common scale. Additional problems arise when assessing interaction effects of several algorithms on the recommender system performance.

Still further, because customer preference is noisy, a certain amount of uncertainty is associated with the recommendations provided by a recommender system. Moreover, the number of products matching a search criterion can vary from single digits to the order of millions, but the number of available slots for displaying recommended products is often limited to a single digit number. The aforementioned uncertainty and the limited number of available slots for the greatly varying number of matching products makes the commonly available evaluation metrics extremely stringent, whereby the metrics tend to penalize the recommender system too much for not being able to predict the one out of thousands of candidate products that match the user's constraints.

Embodiments of the present invention address the aforementioned unique challenges of evaluating personalized search results in an online e-commerce system. Embodiments presented herein employ a new, agnostic, and versatile framework and method for quantifying the effect of changing any parameter within the pipeline being evaluated, where the quantification of the effect is in a common scale. Embodiments of the present invention translate the effects in a well-defined, business-oriented and intuitive manner. The parameter changes are compared across a common scale, which provides a common platform to evaluate and understand the past and present behavior of a recommender system and facilitates a well-informed decision about the recommender system. Embodiments of the present invention do not rely on the presence of any existing precursors such as existing search terms and assesses a recommender system in a manner that is neutral and determines a performance which “might have been,” had the recommender system been available during the time the user had been interacting with the e-commerce portal. In one embodiment, the recommender system disclosed herein operates in a neutral fashion, attaching itself seamlessly to an existing pipeline, without requiring a change in existing processes.

The framework disclosed herein uses a bagging (bootstrapping with aggregation) approach to capture the offline performance in terms of what the evaluation system would have done had the system been available during the actual event of a purchase. The online performance is captured simply by turning off the query simulator and time-splits. Embodiments disclosed herein are suitable for evaluating a personalized search system which is being newly implemented (i.e., a green field implementation), provided the customer's purchase data and other preference data are available. Embodiments of the present invention overcomes the aforementioned peculiarities of the retail domain by providing a ranked similarity based measure to indicate the relevance of the recommendation set. The ranked similarity based measure captures the nuances of a recommender system that is constrained on available slots to display the best-matched items.

Embodiments of the present invention provide an end-to-end plug-and-play framework for evaluating the several sub-processes and algorithms forming a recommendation pipeline. In one embodiment, the framework employs a bagged SIM@K (similarity at rank K) evaluator which simulates taking the current recommender system “back in time” and generates an evaluation report based on a performance that is likely to have been observed had the system been available at a time of the purchase, where the time of the purchase precedes the actual availability of the system.

### System for Evaluating a Recommender System

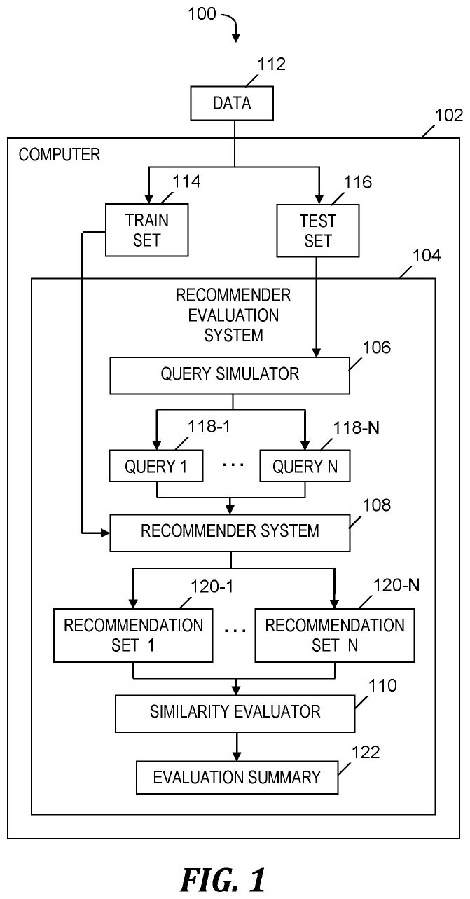

FIG. 1 is a block diagram of a system 100 for evaluating a recommender system, in accordance with embodiments of the present invention. System 100 includes a computer 102, which executes a software-based recommender evaluation system 104, which includes a data query simulator 106, a recommender system 108, and a similarity evaluator 110.

Data 112 specifies interactions between users and an e-commerce portal (not shown), and includes records of purchase data, pageview data, wish list data, electronic shopping cart data, etc. In one embodiment, the aforementioned records in data 112 are associated with users who have had interactions with the e-commerce portal for at least m products (e.g., five products), where m is a configurable integer. A time split based on a timestamp T divides the records in data 112 into a train set 114 and a test set 116. Train set 114 includes a first set of records in data 112 that have respective timestamps that indicate times that are on or before the timestamp T. Test set 116 includes a second set of records in data 112 that have respective timestamps that indicate times that are after timestamp T.

A utility matrix process (not shown) in recommender system 108 receives the records in train set 114 and generates a utility matrix (not shown). A utility matrix includes numeric values that indicate preferences of customers towards products. In one embodiment, a matrix factorization process and one or more other processes use the utility matrix to decompose and generate user features (not shown) and item features (not shown). The matrix factorization process stores the user features and item features in a data repository (not shown) that is accessed by recommender evaluation system 104. Other batch processes including a product similarity process (not shown) and a customer similarity process (not shown) use records from the train set 114 to generate a product similarity matrix (not shown) and a customer similarity matrix (not shown), respectively. The product similarity process generates and stores product similarity measures in the data repository. The customer similarity process generates and stores customer similarity measures in the data repository.

In one embodiment, the recommender system 108 has the functionality of known recommender systems, but is tweaked to accept a new date parameter indicating a given date (or a timestamp parameter indicating a given time and date), which is used to generate a candidate set of records containing only items that were observed by users before the date indicated by the date parameter (or before the time and date indicated by the timestamp parameter).

Using a pseudo-random number generator, recommender evaluation system 104 randomly samples without replacement the records received from test set 116 to generate a set of purchase information of size p. The purchase information includes data about actual purchases of items made by respective users utilizing the e-commerce portal. Items are also referred to herein as products. Users are also referred to herein as customers. Recommender evaluation system 104 excludes from the set of purchase information any records that specify purchases made by users who do not have information in train set 114.

After the aforementioned exclusion of records, query simulator 106 receives the set of purchase information and processes each user-item interaction in the set of purchase information by (1) extracting the attributes that specify the purchased item and (2) using bootstrapping with aggregation, generating query 118-1, . . . , 118-N, where N is an integer greater than one. Queries 118-1, . . . , 118-N are bootstrapped, simulated queries formed by omitting (i.e., dropping) one or more attributes of the purchased item. An attribute is randomly selected for being dropped based on drop probabilities that are associated with the attributes. Recommender evaluation system 104 assigns the drop probabilities based on business intuition or learned from the data 112.

Recommender system 108 receives query 118-1, . . . , query 118-N and processes each query by using only user-item interaction information whose date is on or before the aforementioned purchase date (i.e., recommender system 108 excludes or is unaware of user-item interaction information whose date is after the purchase date). The processing of query 118-1, . . . , 118-N by recommender system 108 generates recommendation set 120-1, . . . , recommendation set 120-N, respectively. Each of recommendation set 120-1, . . . , 120-N includes multiple items recommended for purchase by the user based on the corresponding query included in query 118-1, . . . , query 118-N. Thus, the purchase date is the date the recommender system 108 “goes back to” and the simulated queries are point-in-time queries based on the purchase date. In the case of the recommender system 108 being newly implemented and the purchase date preceding the implementation date of the recommender system 108, the aforementioned processing of query 118-1, . . . , 118-N by recommender system 108 generates recommendation results that would have been expected had the recommender system 108 been available at the time the user made the purchase.

Similarity evaluator 110 receives recommendation set 120-1, . . . , 120-N and measures a proximity of the recommended items to the item actually purchased in the product feature space. By measuring the proximity, recommender evaluation system 104 avoids or minimizes bias that otherwise exists in known techniques that quantify the performance of a query-driven recommender system based on known ranking metrics.

The aforementioned bias can be introduced because user choices are noisy. Often a user who is presented several candidate items chooses one because the user simply feels like making that choice (i.e., the choice may be random and the choice may be different at different times). Penalizing a recommender system for not being able to predict the chosen item out of several thousand potential matches is too stringent, keeping in mind the enormous number of options a retailer hosts and the limitations in the number of items that are presented as recommendations.

The aforementioned bias may also be introduced in retail cases in which the same product is made available under different SKU numbers. In this situation, simply assessing the performance of a recommender system based on a SKU number match (as is done with currently available metrics) results in penalizing the recommender system too much for no apparent reason. A similar case with similar bias arises when different SKUs have essentially the same attributes and differ only in the size of the item (e.g., different SKUs for the same shampoo in different sized containers).

Similarity evaluator 110 generates an evaluation summary 122, which includes an evaluation of the similarity of the recommended items in recommendation set 120-1, . . . , 120-N by using a new similarity at rank K (SIM@K) metric. Evaluation summary 122 also includes a calculation of an average similarity at rank K (Avg. SIM @K), which is an average of SIM@K values over all the users indicated by the user-item pairs in the set of purchase information being processed by recommender evaluation system 104. SIM@K and Avg. SIM@K are discussed in more detail in the next section.

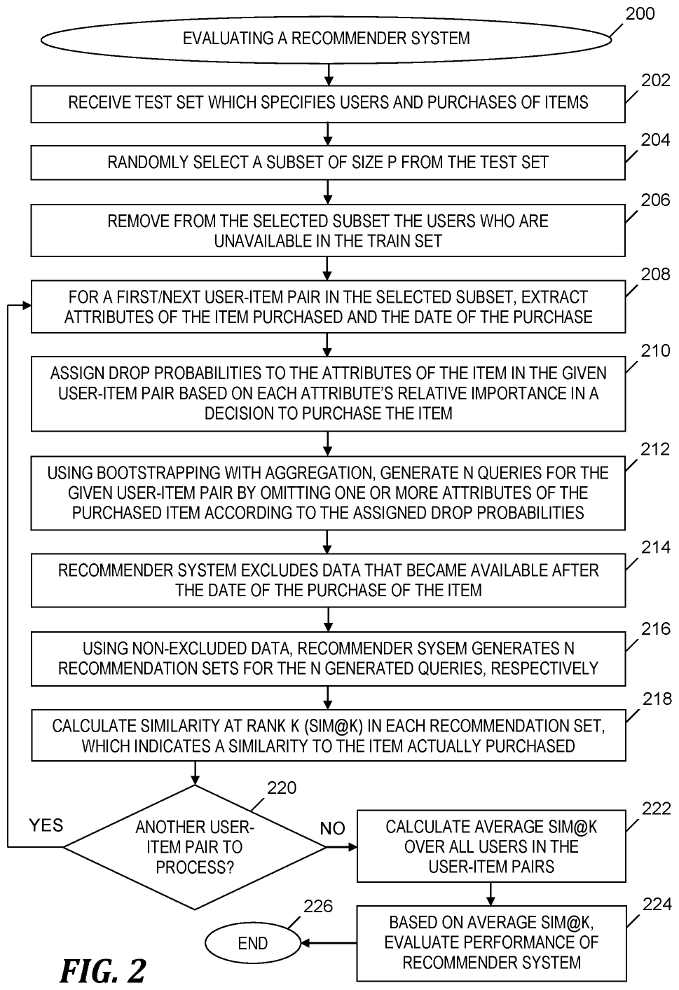

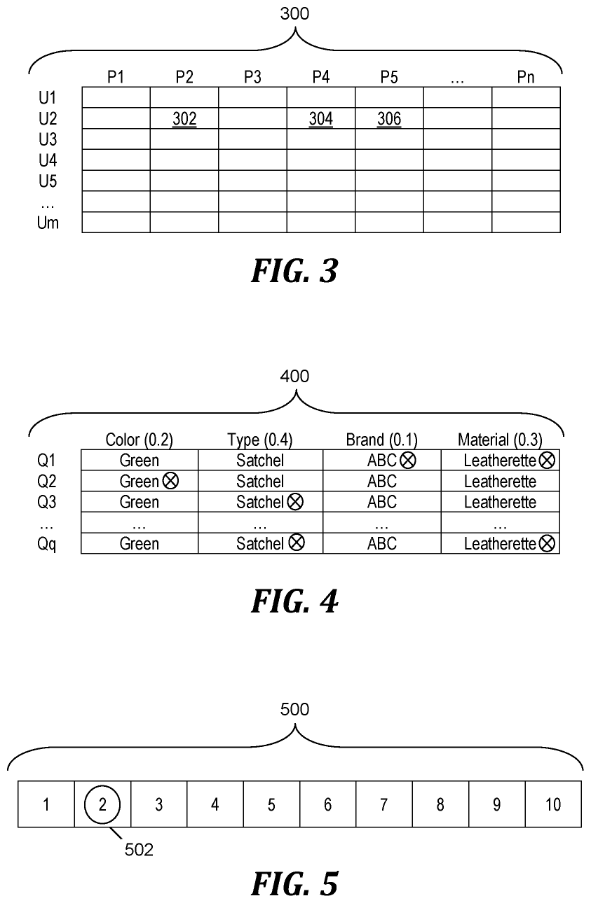

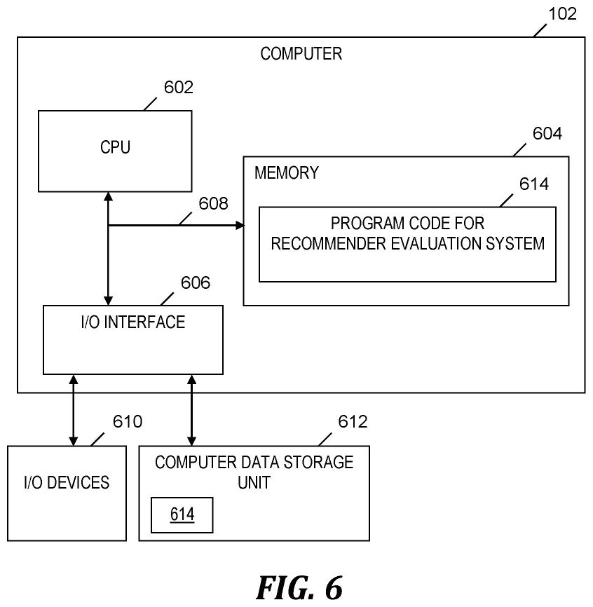

The functionality of the components shown in FIG. 1 is described in more detail in the discussion of FIG. 2, FIG. 3, FIG. 4, FIG. 5, and FIG. 6 presented below.

### Process for Evaluating a Recommender System

FIG. 2 is a flowchart of a process of evaluating a recommender system, where the process is implemented in the system of FIG. 1, in accordance with embodiments of the present invention. The process of FIG. 2 starts at step 200. In step 202, recommender evaluation system 104 (see FIG. 1) receives test set 116 (see FIG. 1) which includes records of user-item pairs, where each pair specifies a user and a purchase of an item by the specified user.

In step 204, recommender evaluation system 104 (see FIG. 1) uses a pseudo-random number generator to randomly select a subset of size P from test set 116 (see FIG. 1).

In step 206, recommender evaluation system 104 (see FIG. 1) removes user-item pairs from the subset selected in step 204, where the removed pairs specify users who are unavailable in train set 114 (see FIG. 1) (i.e., users who are not specified in records in train set 114 (see FIG. 1)).

In step 208, for a first user-item pair in the subset selected in step 204, recommender evaluation system 104 (see FIG. 1) extracts (1) attributes of the purchased item specified by the first user-item pair and (2) a date of the purchase of the purchased item. In subsequent performances of step 208 (see the loop described below), the aforementioned extraction will be for a next user-item pair in the subset selected in step 204 and the purchased item is the item specified by the next user-item pair. In subsequent steps in the process of FIG. 2, the first user-item pair and the next user-item pair referred to in step 208 are referred to simply as “the user-item pair.”

In step 210, recommender evaluation system 104 (see FIG. 1) assigns drop probabilities to the attributes of the purchased item specified by the user-item pair. A drop probability assigned in step 210 is based on the corresponding attribute's relative importance in a decision to purchase the item. The assigned drop probabilities across an entire set of attributes for a given item sum to one.

In step 212, using bootstrapping with aggregation, recommender evaluation system 104 (see FIG. 1) generates N queries (i.e., query 118-1, . . . , 118-N in FIG. 1) for the user-item pair by omitting one or more attributes of the purchased item, where the one or more attributes are selected for omission according to the drop probabilities assigned in step 210. In one embodiment, step 212 generates three to five queries.

In step 214, recommender evaluation system 104 (see FIG. 1) excludes user-item pairs from user-item interactions being considered by recommender system 108 (see FIG. 1), where the excluded user-item pairs specify dates of interactions with the e-commerce portal that are after the date of the purchase of the purchased item (i.e., excludes from consideration data that became available to recommender system 108 (see FIG. 1) after the date of the purchase of the purchased item).

In step 216, using user-item pairs in data 112 (see FIG. 1) that were not excluded in step 214, recommender evaluation system 104 (see FIG. 1) generates N recommendation sets for the N queries generated in step 212, respectively. That is, recommender evaluation system 104 (see FIG. 1) uses only data that became available to the recommender system 108 (see FIG. 1) before the purchase date of the item to generate recommendation set 120-1, . . . , 120-N (see FIG. 1). In one embodiment, each recommendation set has five to eight recommended products.

In one embodiment, recommender system 108 (see FIG. 1) did not exist on the date of the purchase of the item by the user, but the recommender evaluation system 104 (see FIG. 1) runs the generated queries in step 216 as if the recommender system 108 (see FIG. 1) had existed on the date of the purchase of the item.

In step 218, recommender evaluation system 104 (see FIG. 1) calculates similarity at rank K (SIM@K) values for each ranked recommended item in each recommendation set in recommendation sets 120-1, . . . , 120-N (see FIG. 1). Each SIM@K value indicates a similarity (e.g., based on cosine similarity) of the corresponding ranked recommended item to the purchased item. SIM@K indicates how accurately the recommender system 108 (see FIG. 1) predicts what the customer would have liked to have purchased, knowing what the customer had actually purchased. That is, the SIM@K indicates how close the recommender system 108 (see FIG. 1) was in predicting whether the user would like the recommended item or not.

In step 220, recommender evaluation system 104 (see FIG. 1) determines whether there is another user-item pair (i.e., a next user-item pair) in the subset selected in step 204 that has not yet been processed by steps, 208, 210, 212, 214, 216, and 218. If recommender evaluation system 104 (see FIG. 1) determines in step 220 that there is a next user-item pair to process, then the Yes branch is followed, and the process loops back to step 208 to process the next user-item pair in the subset selected in step 204.

If recommender evaluation system 104 (see FIG. 1) determines in step 220 that there is not a next user-item pair in the subset selected in step 204 that remains to be processed by steps 208, 210, 212, 214, 216, and 218, then the No branch of step 220 is followed and step 222 is performed.

In step 222, recommender evaluation system 104 (see FIG. 1) calculates Avg. SIM@K values for each rank over all users in the user-item pairs that were processed by the steps in FIG. 2.

In step 224, based on the Avg. SIM@K values calculated in step 222, recommender evaluation system 104 (see FIG. 1) evaluates a performance of recommender system 108 (see FIG. 1). In one embodiment, the performance of recommender system 108 (see FIG. 1) is evaluated in step 224 as meeting an optimal level of performance, as described below in the discussion of FIG. 4. In one embodiment, the evaluation of an optimal performance in step 224 is an indicator that the recommender system provides accurate product matches even if the recommender system is part of a green field implementation and provides optimal parameter settings that avoid the aforementioned bias.

The process of FIG. 2 ends at step 226.

### EXAMPLES

Recommender evaluation system 104 (see FIG. 1) employs bagging (bootstrapping with aggregation) to ensure that the expected performance is maximized for a given user, as illustrated in the example presented below. Before describing the example, notations are presented below.

A query is represented as:

Q=({attribute 1, attribute 2, . . . , attribute n} |Product Category, Date of Purchase, User ID), i.e., a set of attributes mapped to a Product Category. The Date of Purchase is the date when the actual purchase was made by the user identified by the User ID.

The personalized recommendations are represented as:

RecSet = {
({attribute 1, attribute 2, ..., attribute n} | Product ID 1),
({attribute 1, attribute 2, ..., attribute n} | Product ID 2), ...,
({attribute 1, attribute 2, ..., attribute n} | Product ID N),
}

For mobile applications, N is often very small, usually in the single digits. The ratio Number of products in Candidate Set: Number of products recommended is very large.

The Date of Purchase marks the point in time to which the recommender evaluation system 104 (see FIG. 1) simulates “going back to.” That is, all of the data observed after the Date of Purchase is obliviated from the purview of the recommender system 108 (see FIG. 1).

Query simulator 106 (see FIG. 1) performs the following steps:

1. Perform step 204 (see FIG. 2). From the test set 116 (see FIG. 1), randomly sample a list of p purchase information (i.e., information about actual interactions between users and items). The user and item associated with a given purchase information are referred to herein as a User-Item pair. The interaction between a user and an item is referred to herein as a User-Item interaction.

2. In step 206 (see FIG. 2), exclude the users who do not have information in the train set 114 (see FIG. 1).

3. In step 208 (see FIG. 2), extract the attributes defining the purchased item. In this case, the item has nᵣ attributes, where nᵣ is a positive integer.

4. In step 212 (see FIG. 2), use bootstrapping with aggregation to maximize the expected performance for the selected User-Item pair and generate a sample of q queries pertaining to the chosen User-Item interaction by randomly omitting one or more attributes of the purchased item. In this example, the purchase information specifies “User U2 has purchased Product P5”, P5 is defined by ({color=“Green”, type=“Satchel”, brand=“ABC”, material=“Leatherette”} |“Handbags”), and the Date of Purchase is 21 Dec. 2014.

Simulated queries for this example may include:

Q1=({color=“Green”, type=“Satchel”} |“Handbags”, “21 Dec. 2014”, “U1”)

Q2=({brand=“ABC”, type=“Satchel”, material=“Leatherette”} |“Handbags”, “21 Dec. 2014”, “U1”) . . . .

Qq=({brand=“ABC”, color=“Green”} |“Handbags”, “21 Dec. 2014”, “U1”)

Recommender system 108 (see FIG. 1) is made unaware of information available after the Date of Purchase, “21 Dec. 2014”.

To generate the simulated queries, query simulator 106 (see FIG. 1) randomly drops each attribute according to a given drop probability and the sampling is performed with replacement. The drop probabilities associated with each attribute is determined by business intuition or learned from data 112 (see FIG. 1). The bootstrapped samples are input to recommender system 108 (see FIG. 1) and the performance is aggregated for each User-Item pair. For a sufficient sample size, the expected performance is maximized. The process described above generates the expected performance and indicates the query performance which “might have been” (i.e., is likely to have been), had the recommender system 108 been available at the time the user made the purchase and had the user actually interacted with recommender system 108.

FIG. 3 is an example of a table 300 of user-item pairs in used in the process of FIG. 2, in accordance with embodiments of the present invention. Table 300 includes rows denoting users (i.e., users U1, U2, U3, U4, U5, . . . , Um) and columns denoting items (i.e., items P1, P2, P3, P4, P5, . . . , Pn), where m and n are positive integers. Each cell in table 300 includes the preference of a given item by a given user. In this example, only purchases are considered for evaluation. For this example, consider user U2. Products in the train set 114 (see FIG. 1) for U2 are products P2 and P4 (i.e., [Train]_U2={P2, P4}), as indicated by cells 302 and 304, respectively. The product in the test set 116 (see FIG. 1) for U2 is product P5 (i.e., [Test]_U2={P5}, as indicated by cell 306. Recommender evaluation system 104 (see FIG. 1) uses the items in the train set to build the user U2's profile and other datasets required for generating the recommendations. Recommender evaluation system 104 (see FIG. 1) evaluates the actual purchase of product P5 by user U2 for performance.

P5 is represented as: ({color=“Green”, type=“Satchel”, brand=“ABC”, material=“Leatherette”} |“Handbags”).

For the evaluation of the purchase of product P5, recommender evaluation system 104 (see FIG. 1) obliviates the entirety of information that became available to recommender system 108 (see FIG. 1) after the date of the purchase of product P5.

FIG. 4 is an example of a table 400 of bootstrapped queries used in the process of FIG. 2, in accordance with embodiments of the present invention. Table 400 includes attributes of a handbag (i.e., the attributes of Color, Type, Brand, and Material). The numbers in parentheses after the attribute labels indicate the drop probabilities of the attributes. For example, the attribute of Color has a drop probability of 0.2. Each row in table 400 includes particular values of the attributes for a given generated query included in queries Q1, Q2, Q3, . . . , Qq. A circle with an “X” in it in a cell in table 400 indicates a particular attribute that has been excluded from the given query. For example, the query Q1 has Color=“Green” and Type=“Satchel”, but does not include any values for Brand or Material because the circles with an X in them which are next to the Brand of “ABC” and the Material of “Leatherette” in the row for Q1 indicates that the attributes of Brand and Material are excluded from the query Q1 (i.e., Brand and Material are dropped from query Q1 in step 212 in FIG. 2 according to the drop probabilities of 0.1 and 0.3, which are assigned to Brand and Material, respectively).

For a particular category of items, certain attributes of items in that category may be more important to users who purchase items in that category. For example, if the item is in the category of “Jeans”, “fit” may be a more important attribute than “color.” A greater drop probability indicates that the given attribute is less important while deciding on the purchase of the item (i.e., indicates that the given attribute is more likely to be dropped in a query generated in step 212 in FIG. 2). In table 400, the attribute of Type has a greater drop probability than the attribute of Brand (i.e., 0.4 is greater than 0.1), and therefore Type is more likely be dropped from a generated query than Brand, and Type is less important than Brand to a user deciding on the purchase of a hand bag.

The performance of the recommender system is aggregated across all the bootstrapped queries for each identified User-Item pair. To avoid the biases of conventional ranking metrics, recommender evaluation system 104 (see FIG. 1) measures the proximity of the recommended items and the actually purchased item in the product feature space. Similarity evaluator 110 (see FIG. 1) uses the SIM@K metric to evaluate the similarity of the recommended items to the item actually purchased by the user. Similarity evaluator 110 (see FIG. 1) calculates the average similarity at rank K (Avg. SIM@K) over all users under evaluation. For example, consider the following input query:

Q=({attribute 1, attribute 2, . . . , attribute n} |Product Category, User 1)

The purchased product corresponding to query Q is:

({attribute 1, attribute 2, . . . , attribute n} |Product 2)

The recommendation set containing the personalized recommendations is:

RecSet = {
({attribute 1, attribute 2, ..., attribute n} | Product 1),
({attribute 1, attribute 2, ..., attribute n} | Product 2),
...
({attribute 1, attribute 2, ..., attribute n} | Product 10)
}

The ten products recommended are shown as 1, 2, . . . , 10 in the cells of table 500 in FIG. 5. Cell 502 in table 500 includes a circle around the “2” indicating that Product 2 is the product actually purchased and that similarity evaluator 110 (see FIG. 1) determines the similarity of each product in the recommendation set to Product 2. For the aforementioned recommendation set having the ten products, similarity evaluator 110 (see FIG. 1) calculates the following:

Similarity at 1, SIM@1: sim(RecSet[1], Product 2)

Similarity at 2, SIM@2: sim(RecSet[2], Product 2), etc.

Average Similarity at 1, Avg. SIM@1: (1/nᵤ)*Σ(SIM@1),

Average Similarity at 2, Avg. SIM@2: (1/nᵤ)*Σ(SIM@2), etc.

In the calculations presented above for average similarity, nᵤ is the number of users under evaluation. Recommender evaluation system 104 evaluates a recommender system as being “good” (i.e., meeting an optimal level of performance) based on the average similarity values decreasing as the ranks are traversed from top to bottom ranks (or based on the average similarity values remaining similar to each other within a predetermined threshold amount as the ranks are traversed from top to bottom ranks). In other words, recommender evaluation system 104 determines that a first recommender system is better than a second recommender system if the average similarity calculations for the first recommender system decrease (or remain similar) as the ranks are traversed from the top rank to the bottom rank and the average similarity calculations for the second recommender system do not decrease (or do not remain similar) for the same traversal of the ranks from top rank to bottom rank.

### Computer System

FIG. 6 is a block diagram of a computer included in the system of FIG. 1 and that implements the process of FIG. 2, in accordance with embodiments of the present invention. Computer 102 is a computer system that generally includes a central processing unit (CPU) 602, a memory 604, an input/output (I/O) interface 606, and a bus 608. Further, computer 102 is coupled to I/O devices 610 and a computer data storage unit 612. CPU 602 performs computation and control functions of computer 102, including executing instructions included in program code 614 for recommender evaluation system 104 (see FIG. 1) to perform a method of evaluating a recommender system, where the instructions are executed by CPU 602 via memory 604. CPU 602 may include a single processing unit or be distributed across one or more processing units in one or more locations (e.g., on a client and server).

Memory 604 includes a known computer readable storage medium, which is described below. In one embodiment, cache memory elements of memory 604 provide temporary storage of at least some program code (e.g., program code 614) in order to reduce the number of times code must be retrieved from bulk storage while instructions of the program code are executed. Moreover, similar to CPU 602, memory 604 may reside at a single physical location, including one or more types of data storage, or be distributed across a plurality of physical systems in various forms. Further, memory 604 can include data distributed across, for example, a local area network (LAN) or a wide area network (WAN).

I/O interface 606 includes any system for exchanging information to or from an external source. I/O devices 610 include any known type of external device, including a display, keyboard, etc. Bus 608 provides a communication link between each of the components in computer 102, and may include any type of transmission link, including electrical, optical, wireless, etc.

I/O interface 606 also allows computer 102 to store information (e.g., data or program instructions such as program code 614) on and retrieve the information from computer data storage unit 612 or another computer data storage unit (not shown). Computer data storage unit 612 includes a known computer readable storage medium, which is described below. In one embodiment, computer data storage unit 612 is a non-volatile data storage device, such as, for example, a solid-state drive (SSD), a network-attached storage (NAS) array, a storage area network (SAN) array, a magnetic disk drive (i.e., hard disk drive), or an optical disc drive (e.g., a CD-ROM drive which receives a CD-ROM disk or a DVD drive which receives a DVD disc).

Memory 604 and/or storage unit 612 may store computer program code 614 that includes instructions that are executed by CPU 602 via memory 604 to evaluate a recommender system. Although FIG. 6 depicts memory 604 as including program code, the present invention contemplates embodiments in which memory 604 does not include all of code 614 simultaneously, but instead at one time includes only a portion of code 614.

Further, memory 604 may include an operating system (not shown) and may include other systems not shown in FIG. 6.

In one embodiment, computer data storage unit 612 includes a data repository that includes test set 116, train set 114, item attributes, and information about user interactions with the e-commerce portal, including user purchases of items.

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to evaluating a recommender system. Thus, an embodiment of the present invention discloses a process for supporting computer infrastructure, where the process includes providing at least one support service for at least one of integrating, hosting, maintaining and deploying computer-readable code (e.g., program code 614) in a computer system (e.g., computer 102) including one or more processors (e.g., CPU 602), wherein the processor(s) carry out instructions contained in the code causing the computer system to evaluate a recommender system. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of evaluating a recommender system.

While it is understood that program code 614 for evaluating a recommender system may be deployed by manually loading directly in client, server and proxy computers (not shown) via loading a computer-readable storage medium (e.g., computer data storage unit 612), program code 614 may also be automatically or semi-automatically deployed into computer 102 by sending program code 614 to a central server or a group of central servers. Program code 614 is then downloaded into client computers (e.g., computer 102) that will execute program code 614. Alternatively, program code 614 is sent directly to the client computer via e-mail. Program code 614 is then either detached to a directory on the client computer or loaded into a directory on the client computer by a button on the e-mail that executes a program that detaches program code 614 into a directory. Another alternative is to send program code 614 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 614 is transmitted to the proxy server and then it is stored on the proxy server.

Another embodiment of the invention provides a method that performs the process steps on a subscription, advertising and/or fee basis. That is, a service provider can offer to create, maintain, support, etc. a process of evaluating a recommender system. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 604 and computer data storage unit 612) having computer readable program instructions 614 thereon for causing a processor (e.g., CPU 602) to carry out aspects of the present invention.

The computer readable storage medium can be a tangible device that can retain and store instructions (e.g., program code 614) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 614) described herein can be downloaded to respective computing/processing devices (e.g., computer 102) from a computer readable storage medium or to an external computer or external storage device (e.g., computer data storage unit 612) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 614) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 6) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 614).

These computer readable program instructions may be provided to a processor (e.g., CPU 602) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 612) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 614) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of evaluating a recommender system, the method comprising:
extracting, by one or more processors, a date of a purchase of an item by a user and attributes of the item, the attributes and the date being extracted from a test set of data which is included in an initial data set specifying interactions between users and items;
assigning, by the one or more processors, drop probabilities to the attributes of the item based on measures of importance of the respective attributes in a decision by the user to purchase the item;
using bootstrapping with aggregation, generating, by the one or more processors, n queries for the user and the item by omitting one or more attributes from each of the queries according to the assigned drop probabilities;
identifying, by the one or more processors, data that became available to the recommender system after the date of the purchase of the item, the identified data being included in the initial data set and specifying interactions between one or more users and one or more items;
without using the identified data and using data that became available to the recommender system before the date of the purchase of the item, generating, by the one or more processors, n recommendation sets for the n queries, respectively, each recommendation set having ranked items recommended for purchase by the user;
calculating, by the one or more processors, similarity at rank K (SIM@K) values for respective recommendation sets, a SIM@K value calculated for a given recommendation set indicating a similarity of a given ranked item in the given recommendation set to the item purchased by the user;
repeating, by the one or more processors and for one or more other users and one or more other users whose interactions are specified in the test set of data, the extracting the date and the attributes, the assigning the drop probabilities, the generating the n queries, the identifying the data that became available to the recommender system after the date of the purchase of the item, the generating the n recommendation sets for the n queries, and the calculating the SIM@K values;
calculating, by the one or more processors, average SIM@K values over multiple users specified in the test set of data; and
based on the average SIM@K values, evaluating, by the one or more processors, a performance of the recommender system.

2. The method of claim 1, further comprising:
receiving, by the one or more processors, the test set of data;
using a pseudo-random number generator, randomly selecting, by the one or more processors, a subset of the test set of data; and
modifying, by the one or more processors, the subset by removing data from the subset, the removed data being associated with a set of users who are unavailable in a train set of data, the train set of data being included in the initial data set, and the test set and the train set being mutually exclusive sets, wherein the extracting the date and the attributes is performed using the modified subset of the test set of data, without using other data included in the test set of data that is not in the modified subset.

3. The method of claim 2, wherein the calculating the average SIM@K values includes calculating a first average SIM@K value at a first rank by calculating (1/nᵤ)*summation of SIM@K values for the first rank over nᵤ users specified in the modified subset of the test set of data, and wherein nᵤ is an integer greater than one.

4. The method of claim 1, further comprising:
evaluating, by the one or more processors, a performance of a first recommender system based on a calculation of a first set of average SIM@K values over a first set of users specified in a first subset of the test set of data;
evaluating, by the one or more processors, a performance of a second recommender system based on a calculation of a second set of average SIM@K values over a second set of users specified in a second subset of the test set of data;
determining, by the one or more processors, that average SIM@K values in the first set of average SIM@K values decrease as first respective rank values increase;
determining, by the one or more processors, that at least some average SIM@K values in the second set of average SIM@K values increase as second respective rank values increase; and
based on the average SIM@K values in the first set decreasing as the first respective rank values increase and the at least some average SIM@K values in the second set increasing as the second respective rank values increase, determining, by the one or more processors, that the evaluated performance of the first recommender system is greater than the evaluated performance of the second recommender system.

5. The method of claim 1, further comprising:
generating, by the one or more processors, the initial data set by combining data specifying purchases of a first set of items, pageviews that specify a second set of items, wish lists that specify a third set of items, and information from electronic shopping carts that specify a fourth set of items; and
dividing, by the one or more processors, the initial data set into the test set and a train set, so that the test set has first preference data whose date is after a given timestamp and the train set has second preference data whose date is on or before the given timestamp.

6. The method of claim 1, further comprising modifying, by the one or more processors, the recommender system to accept a date parameter and permit a performance of the generating the n recommendation sets by using the date parameter to store the date of the purchase of the item and by using a candidate set of data included in the test set of data, wherein the candidate set of data has dates that precede the date of the purchase of the item stored in the date parameter.

7. The method of claim 1, wherein the evaluating the performance of the recommender system does not require existing search strings and does not require results of processing the existing search strings by the recommender system, and wherein the evaluating the performance of the recommender system is performed even though the recommender system is newly implemented.

8. The method of claim 1, further comprising:
providing at least one support service for at least one of creating, integrating, hosting, maintaining, and deploying computer readable program code in the computer, the program code being executed by a processor of the computer to implement (i) the extracting the date of the purchase of the item and the attributes of the item, (ii) the assigning the drop probabilities to the attributes, (iii) the generating the n queries for the user and the item, (iv) the identifying the data that became available to the recommender system after the date of the purchase of the item, (v) the generating the n recommendation sets for the n queries, (vi) the calculating the SIM@K values, (vii) the repeating (i) through (vi) inclusive, (viii) the calculating the average SIM@K values, and (ix) the evaluating the performance of the recommender system.

9. A computer program product comprising:
a computer readable storage medium having computer readable program code stored on the computer readable storage medium, the computer readable program code being executed by a central processing unit (CPU) of a computer system to cause the computer system to perform a method of evaluating a recommender system, the method comprising the steps of:
the computer system extracting a date of a purchase of an item by a user and attributes of the item, the attributes and the date being extracted from a test set of data which is included in an initial data set specifying interactions between users and items;
the computer system assigning drop probabilities to the attributes of the item based on measures of importance of the respective attributes in a decision by the user to purchase the item;
using bootstrapping with aggregation, the computer system generating n queries for the user and the item by omitting one or more attributes from each of the queries according to the assigned drop probabilities;
the computer system identifying data that became available to the recommender system after the date of the purchase of the item, the identified data being included in the initial data set and specifying interactions between one or more users and one or more items;
without using the identified data and using data that became available to the recommender system before the date of the purchase of the item, the computer system generating n recommendation sets for the n queries, respectively, each recommendation set having ranked items recommended for purchase by the user;
the computer system calculating similarity at rank K (SIM@K) values for respective recommendation sets, a SIM@K value calculated for a given recommendation set indicating a similarity of a given ranked item in the given recommendation set to the item purchased by the user;
the computer system repeating, for one or more other users and one or more other users whose interactions are specified in the test set of data, the extracting the date and the attributes, the assigning the drop probabilities, the generating the n queries, the identifying the data that became available to the recommender system after the date of the purchase of the item, the generating the n recommendation sets for the n queries, and the calculating the SIM@K values;
the computer system calculating average SIM@K values over multiple users specified in the test set of data; and
based on the average SIM@K values, the computer system evaluating a performance of the recommender system.

10. The computer program product of claim 9, wherein the method further comprises:
the computer system receiving the test set of data;
using a pseudo-random number generator, the computer system randomly selecting a subset of the test set of data; and
the computer system modifying the subset by removing data from the subset, the removed data being associated with a set of users who are unavailable in a train set of data, the train set of data being included in the initial data set, and the test set and the train set being mutually exclusive sets, wherein the extracting the date and the attributes is performed using the modified subset of the test set of data, without using other data included in the test set of data that is not in the modified subset.

11. The computer program product of claim 10, wherein the calculating the average SIM@K values includes calculating a first average SIM@K value at a first rank by calculating (1/nᵤ)*summation of SIM@K values for the first rank over nᵤ users specified in the modified subset of the test set of data, and wherein nᵤ is an integer greater than one.

12. The computer program product of claim 9, wherein the method further comprises:
the computer system evaluating a performance of a first recommender system based on a calculation of a first set of average SIM@K values over a first set of users specified in a first subset of the test set of data;
the computer system evaluating a performance of a second recommender system based on a calculation of a second set of average SIM@K values over a second set of users specified in a second subset of the test set of data;
the computer system determining that average SIM@K values in the first set of average SIM@K values decrease as first respective rank values increase;
the computer system determining that at least some average SIM@K values in the second set of average SIM@K values increase as second respective rank values increase; and
based on the average SIM@K values in the first set decreasing as the first respective rank values increase and the at least some average SIM@K values in the second set increasing as the second respective rank values increase, the computer system determining that the evaluated performance of the first recommender system is greater than the evaluated performance of the second recommender system.

13. The computer program product of claim 9, wherein the method further comprises:
the computer system generating the initial data set by combining data specifying purchases of a first set of items, pageviews that specify a second set of items, wish lists that specify a third set of items, and information from electronic shopping carts that specify a fourth set of items; and
the computer system dividing the initial data set into the test set and a train set, so that the test set has first preference data whose date is after a given timestamp and the train set has second preference data whose date is on or before the given timestamp.

14. The computer program product of claim 9, wherein the method further comprises the computer system modifying the recommender system to accept a date parameter and permit a performance of the generating the n recommendation sets by using the date parameter to store the date of the purchase of the item and by using a candidate set of data included in the test set of data, wherein the candidate set of data has dates that precede the date of the purchase of the item stored in the date parameter.

15. A computer system comprising:
a central processing unit (CPU);
a memory coupled to the CPU; and
a computer readable storage medium coupled to the CPU, the computer readable storage medium containing instructions that are executed by the CPU via the memory to implement a method of evaluating a recommender system, the method comprising the steps of:
the computer system extracting a date of a purchase of an item by a user and attributes of the item, the attributes and the date being extracted from a test set of data which is included in an initial data set specifying interactions between users and items;
the computer system assigning drop probabilities to the attributes of the item based on measures of importance of the respective attributes in a decision by the user to purchase the item;
using bootstrapping with aggregation, the computer system generating n queries for the user and the item by omitting one or more attributes from each of the queries according to the assigned drop probabilities;
the computer system identifying data that became available to the recommender system after the date of the purchase of the item, the identified data being included in the initial data set and specifying interactions between one or more users and one or more items;
without using the identified data and using data that became available to the recommender system before the date of the purchase of the item, the computer system generating n recommendation sets for the n queries, respectively, each recommendation set having ranked items recommended for purchase by the user;
the computer system calculating similarity at rank K (SIM@K) values for respective recommendation sets, a SIM@K value calculated for a given recommendation set indicating a similarity of a given ranked item in the given recommendation set to the item purchased by the user;
the computer system repeating, for one or more other users and one or more other users whose interactions are specified in the test set of data, the extracting the date and the attributes, the assigning the drop probabilities, the generating the n queries, the identifying the data that became available to the recommender system after the date of the purchase of the item, the generating the n recommendation sets for the n queries, and the calculating the SIM@K values;
the computer system calculating average SIM@K values over multiple users specified in the test set of data; and
based on the average SIM@K values, the computer system evaluating a performance of the recommender system.

16. The computer system of claim 15, wherein the method further comprises:
the computer system receiving the test set of data;
using a pseudo-random number generator, the computer system randomly selecting a subset of the test set of data; and
the computer system modifying the subset by removing data from the subset, the removed data being associated with a set of users who are unavailable in a train set of data, the train set of data being included in the initial data set, and the test set and the train set being mutually exclusive sets, wherein the extracting the date and the attributes is performed using the modified subset of the test set of data, without using other data included in the test set of data that is not in the modified subset.

17. The computer system of claim 16, wherein the calculating the average SIM@K values includes calculating a first average SIM@K value at a first rank by calculating (1/nᵤ)*summation of SIM@K values for the first rank over nᵤ users specified in the modified subset of the test set of data, and wherein nᵤ is an integer greater than one.

18. The computer system of claim 15, wherein the method further comprises:
the computer system evaluating a performance of a first recommender system based on a calculation of a first set of average SIM@K values over a first set of users specified in a first subset of the test set of data;
the computer system evaluating a performance of a second recommender system based on a calculation of a second set of average SIM@K values over a second set of users specified in a second subset of the test set of data;
the computer system determining that average SIM@K values in the first set of average SIM@K values decrease as first respective rank values increase;
the computer system determining that at least some average SIM@K values in the second set of average SIM@K values increase as second respective rank values increase; and
based on the average SIM@K values in the first set decreasing as the first respective rank values increase and the at least some average SIM@K values in the second set increasing as the second respective rank values increase, the computer system determining that the evaluated performance of the first recommender system is greater than the evaluated performance of the second recommender system.

19. The computer system of claim 15, wherein the method further comprises:
the computer system generating the initial data set by combining data specifying purchases of a first set of items, pageviews that specify a second set of items, wish lists that specify a third set of items, and information from electronic shopping carts that specify a fourth set of items; and
the computer system dividing the initial data set into the test set and a train set, so that the test set has first preference data whose date is after a given timestamp and the train set has second preference data whose date is on or before the given timestamp.

20. The computer system of claim 15, wherein the method further comprises the computer system modifying the recommender system to accept a date parameter and permit a performance of the generating the n recommendation sets by using the date parameter to store the date of the purchase of the item and by using a candidate set of data included in the test set of data, wherein the candidate set of data has dates that precede the date of the purchase of the item stored in the date parameter.
